(19) United States
(12) Patent Application Publication
(10) Pub. No.: US 2006/0230837 A1
(43) Pub. Date: Oct. 19, 2006

(54) Apparatus and method for use in measuring fluid flow and pressures

(76) Inventor: Robert C. Wilson, San Luis Obispo, CA (US)

Correspondence Address: MCNEES, WALLACE & NURICK LLC, 100 PINE STREET, P.O. BOX 1166, HARRISBURG, PA, 17108-1166, US

(21) Appl. No.: 11/105,934

(22) Filed: Apr. 13, 2005

(51) Int. Cl. G01L 15/00

(52) U.S. Cl. 73/736

(57) ABSTRACT

The present embodiments provide methods, apparatuses, and systems for use in measuring volume of fluid flow and/or pressures. Some embodiments providing apparatuses for use in measuring pressures include a manometer comprising a conduit with a curved portion that is substantially half parabolic in shape. A pattern of markings is spaced along the curved portion of the conduit, and a displacement fluid is maintained within the conduit such that the displacement fluid is forced along at least a portion of the curved portion of the conduit when the manometer is subject to a pressure difference.

### FIELD OF THE INVENTION

The present invention relates generally to measuring pressure, and more particularly to measuring pressure differences of flowing fluids.

### BACKGROUND

The determination of rate or amount of fluid flow is important in the operation of many systems and critical in optimal operation of some systems. For example, knowing the air flow to a fuel combustion engine can be critical to the optimization or maximization of the engine performance. As such, there have been many devices developed to measure fluid flow rates. One example is the use of pressure differences as fluid (e.g., air) is pushed through a known metering apparatus. By moving air along a conduit in which a known metering apparatus is contained, a pressure difference is generated. The engine can be attached to an input or exit of the conduit through which air is either pushed or drawn. Based on a measured pressure differential through the known metering apparatus, the fluid flow to or from the engine can be determined.

Manometers have been used for decades to measure pressure differences. Based on the measured pressure differences, the fluid flow can be determined. By cooperating a manometer with a pressure source differential, the pressure difference can be determined based on the rise of a fluid within the manometer.

Previous fluid displacement manometers include vertically oriented manometers and inclined manometers. These types of manometers provided moderate results in the measure of pressure differences. However, these devices are typically not effective for accurately measuring at least relatively low pressure differentials.

### SUMMARY OF THE EMBODIMENTS

The present invention advantageously addresses the needs above as well as other needs through the provision of the method, apparatus, and system for use in measuring volume of fluid flow and/or pressures. An apparatus for use in measuring pressures can include a manometer comprising a conduit having a curved portion that is substantially half parabolic in shape; a pattern of markings spaced along the curved portion of the conduit; and fluid maintained within the conduit that is forced along at least a portion of the curved portion of the conduit when the manometer is subject to a pressure difference.

Some embodiments provide apparatuses for use in measuring fluid flow. These apparatuses include a manometer comprising a conduit having a curved portion; a pattern of markings substantially linearly spaced along the curved portion of the conduit; and a manometer fluid maintained within the conduit that is forced along at least a portion of the curved portion of the conduit when the manometer is subject to a pressure difference.

The present embodiments further provide methods for use in calibrating a scale or pattern markings positioned along a manometer. These methods comprise positioning an initial adjustable pattern of markings on the curved portion of the conduit; adding fluid to the manometer to a level where a meniscus of the fluid is at a first marking in the pattern of markings on the conduit; applying a first known pressure to the manometer and reading a first marking that the meniscus of the fluid reaches; and adjusting the pattern of markings to correspond with the first known pressure level.

A better understanding of the features and advantages of the present invention will be obtained by reference to the following detailed description of the invention and accompanying drawings which set forth illustrative embodiments in which the principles of the invention are utilized.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 depicts a simplified plane view of a manometer according to some present embodiments;

FIG. 2 depicts a simplified, enlarged view of a conduit and curved portion of the manometer of FIG. 1;

FIG. 3 shows an approximate half parabolic curve graphically representing the half parabolic shape of the curved portion of a manometer according to some embodiments;

FIG. 4 depicts a cross-sectional view of a source conduit with a flow restriction plate positioned perpendicular to the length of the source conduit;

FIG. 5 depicts a simplified block diagram of a typical incline manometer;

FIG. 6 depicts a further zoomed in view of a section of the curved portion of FIG. 2 with known pressure applied across to one or both of the terminations of the manometer;

FIG. 7 depicts a simplified flow diagram of a process for use in the calibration of the scale of a manometer of the present embodiment to provide accurate measurements of unknown pressures and/or flows; and

FIG. 8 depicts a simplified cross-sectional view of a measurement system for use in measuring fluid flow;

FIG. 9 depicts a partial cross-sectional view of a pressure measurement system according to some embodiments with a flow restriction orifice disk that includes a plurality of orifices, each with a different diameter;

FIG. 10 depicts a simplified cross-sectional view of a flow bench system for use in measuring fluid flow according to some embodiments;

FIG. 11 depicts a simplified cross-sectional view of an alternate measurement flow bench system according to some embodiments for use in measuring fluid flow;

FIG. 12 depicts a simplified block diagram of a flow bench according to some embodiments, with an adaptor, a piezometric ring, and one or more manometers, including a first half parabolic manometer of FIG. 1;

FIG. 13 depicts a simplified, partially transparent isometric view of the adaptor and piezometric ring of FIG. 12;

FIG. 14 depicts a partial transparent isometric view of the piezometric ring cooperated with the source passage and reference manometer;

FIG. 15 depicts an overhead view of the piezometric ring cooperated with the source passage; and

FIG. 16 depicts a cross-sectional view of the adaptor and piezometric ring according to some implementations.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The present embodiments provide systems and methods for use in measuring the flow of fluids, as well as measuring pressures and differences in pressures. In some preferred implementations, the present embodiments can be employed as a manometer for use with a flow bench. In measuring fluid flows and/or pressures the present embodiments provide a configuration and an accurate and simple scale or pattern of marks that is easily read providing for more accurate readings. Further, the present embodiments can be used to measure substantially any relevant pressure or pressure differences. For example, the measurement system can be a manometer for measuring a pressure different of a fluid flow, whether liquid or gas, passing through a conduit that has a variation in pressure (e.g., due to some pressure restriction, expansion or other such change or interference along the conduit). Typically with these types of measurements, the behavior of the pressure relative to an increase in a volume of flow is nonlinear. The present embodiments in part compensate for this nonlinear relationship by providing a measurement device that substantially mimics the nonlinear relationship and thus provides for a more precise and accurate measure.

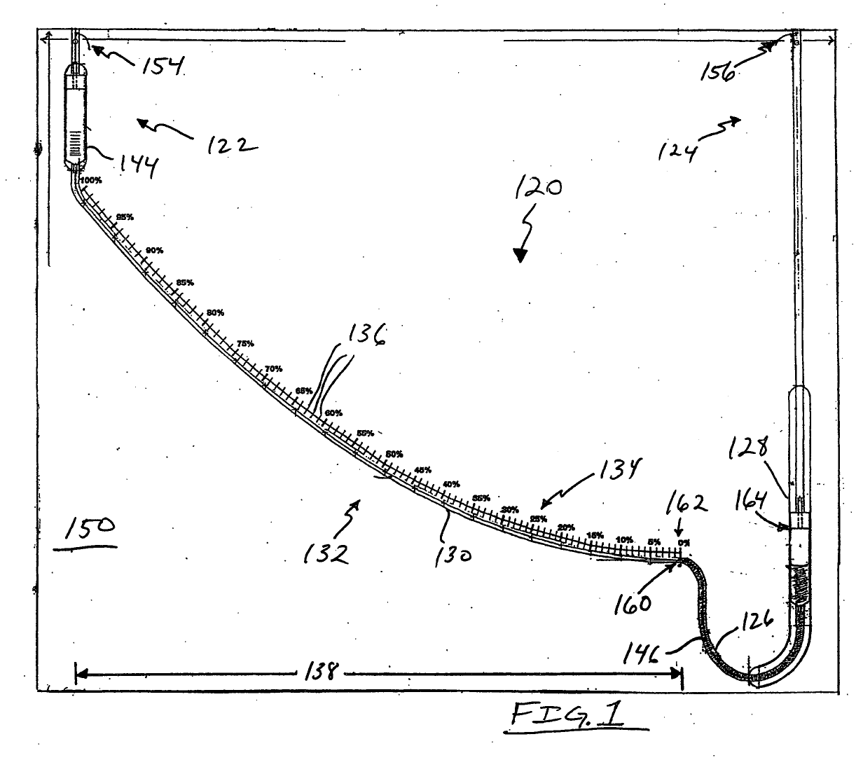

FIG. 1 depicts a simplified plane view of a manometer 120 according to some present embodiments. The manometer includes a first end 122, a second end 124, a reservoir 126, a reservoir, well or accumulator 128, a conduit 130 with a curved measurement portion 132, a pattern of markings or a scale 134 with graduations 136 extending along at least a portion of the length 138 of the curved portion, an overpressure accumulator 144, and displacement fluid 146 retained within the manometer. Typically, the manometer 120 is mounted or secured with a board, plate or other support structure 150. The first and/or second ends 122, 124 can further include terminations 154, 156 that can be fitted with a pressure source from which the manometer 120 measures pressure and/or a pressure difference. In some implementations, the terminations include pressure taps that couple with pressure sources as described below. At static conditions where the fluid 146 is zeroed, the fluid resides in the reservoir 126 and well 128. Pressure differences across the two terminations cause the fluid within the reservoir and/or well to be displaced along the conduit 130 and scale 134.

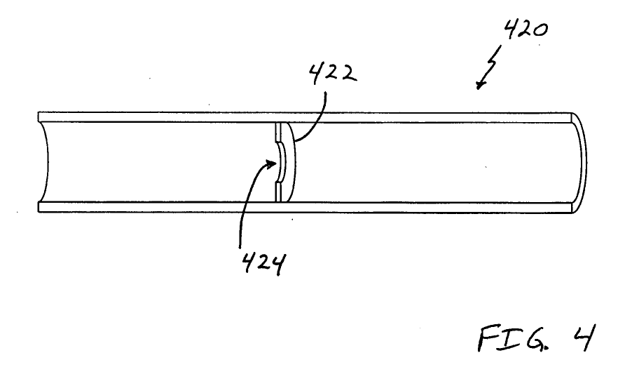

The manometer 120 can be used to measure and/or quantify a fluid flow. Additionally, the manometer can measure the pressure difference between two sources by connecting one of the terminal ends 154, 156 to each source. The two sources can be independent sources, dependent sources, a first source supplying a second source (e.g., a change in volume between sources, a partial obstruction between the two sources, and the like), and other configurations of sources. Similarly, the manometer 120 can be used to measure pressures difference from atmospheric pressure by connecting one of the terminal ends 154, 156 to a measurement pressure source and venting the opposite terminal end. In measuring a fluid flow in some implementations, one or both of the terminations 154, 156 cooperate with a source conduit 420 (see FIG. 4) through which fluid is forced. The flowing fluid can be substantially any relevant fluid, whether liquid, gas or some combination (e.g., oxygen, air, fuel, exhaust from an engine, and substantially any other relevant fluid). By detecting a pressure difference the volume of flowing fluid can be easily determined and quantified.

The reservoir 126 is shown in FIG. 1 as a U-shaped or horse shoe shaped reservoir that maintains the reserve of displacement fluid 146 that is forced along the curved portion 132 of the conduit 130 when measuring. The U-shape further allows for rapid zeroing of the fluid as described below. Other shapes besides a U-shape can be employed as are known to retain the reserve of fluid 146. The displacement fluid 146 can be water, oil, mercury, a glycol, and other relevant liquids and/or combinations of liquids. In some embodiments, a wetting agent (e.g., Water Wetters® from Red Line Synthetic Oil Corporation of Benicia, Calif.) is added to the displacement fluid 146, such as with water to allow the water to more easily pass along the conduit and prevent separation of the water and provide an accurate measure of pressure or flow. For example, the wetting agent can be added at a ratio of one to four. Additionally, a coloring or dye can be added to the displacement fluid 146 to allow the liquid to be more readily viewed by the user.

The displacement fluid in the U-shaped reservoir 126 prior to pressure measuring is set at a level so that a meniscus 160 is positioned at a predefined zero point 162 of the curved portion. The U-shaped reservoir 126 provides a slack that allows the fluid to slide up and down allowing rapid zeroing. The zero point is typically the point along the curved portion at which equal pressure is applied to both the first and second terminal ends 154, 156. However, the zero point can be a point from which the pressure difference is measured based on two pressures which are initially different. In some embodiments, the well 128 further includes a syringe or other such device 164 cooperated with the reservoir 126. In some embodiments one or more check valves (e.g., with a floating ball suspended on a spring) can be employed in the event of over-pressurization of the accumulator 144 and/or well 128. The syringe 164 is configured to deliver and/or remove displacement fluid quickly and easily to adjust the positioning of the meniscus 160 to the zero point 162. In some implementations, the syringe is configured to move along a generally vertical direct providing displacement of the fluid. Because the fluid is subject to evaporation, the fluid levels can change over time. As such, the displacement fluid 146 of the manometer 120 is typically zeroed prior to use in order to obtain a more accurate reading of pressure. An additional syringe can couple with the well 128 and/or reservoir 126 in some implementations so that addition fluid 146 can easily be removed or added at precise amounts to aid in accurately zeroing the fluid relative to the curved portion 132 and the scale 134. The overflow accumulator 144, in some implementations is similarly implemented with a modified syringe or other such devices.

The zeroing of the manometer 120 in some implementations includes insert a loading tube assembly into the top of accumulator 128, a syringe is attached to the other end of manometer tubing (e.g., terminal end 154) and displacement fluid 146 is drawn into the reservoir 126 and/or accumulator 128. For example, some implementations of the manometer 120 use about 6 milliliters of manometer fluid. After fluid is drawn into the reservoir, the loading tube is removed from the manometer fluid and the suction syringe is removed from the terminal end, allow fluid to stabilize. The manometer 120 is further zeroed by sliding accumulator 128 up or down in a slot to bring fluid to the zero point 162. If fluid will not zero, displacement fluid is added or subtracted as required to allow fluid to zero.

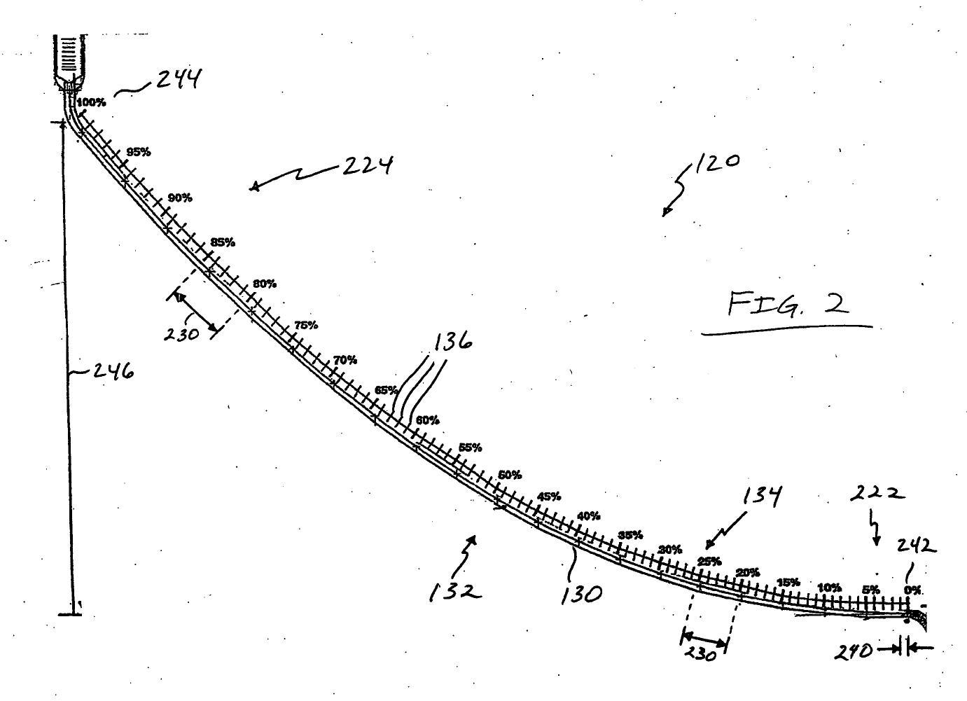

FIG. 2 depicts a simplified, enlarged view of the curved portion 132 of the conduit 130 of the manometer 120 of FIG. 1. The conduit can be constructed of plastic, polyurethane, glass, and other such relevant material. For example, the conduit 130 can be constructed of a flexible plastic tubing that has a ¼ inch diameter with a e,fra 1/8 inch diameter inner bore. The conduit is secured with the board 150 (e.g., glued into a groove shaped to correspond with the desired curvature). The interior of the conduit is treated in some embodiments to provide a smoother surface and prevent separation and/or adhesion of the liquid with the interior of the conduit. For example, the interior of a polyurethane conduit can be sandblasted to smooth the interior surface and reduce surface tensions. The addition of a wetting agent, as introduced above, with some displacement fluids 146 further aids in avoiding separation or beading of the fluids along the curved portion.

Typically, the conduit has a circular cross-section through which the displacement fluid 146 is forced. The cross-section of the conduit, however, can have other shapes, such as square, oval and other relevant configurations. The curved portion 132 of the manometer 120 is specifically configured to provide a more equally distributed variation of pressure change along the length 138 of the curved portion. In some embodiments, the curved portion has generally a half parabolic shape. By incorporating a half parabolic shape the lower portion 222 of the curved portion slightly deviates from horizontal and the slope of the curve continues to increase along the length of the curved portion such that the upper portion 224 has a much greater slope than the lower portion in some implementations the slope of the upper portion 224 approaches vertical, and in some embodiments the slope never becomes vertical, depending on the configuration and/or expected implementation of the manometer. The half parabolic shape of the curved portion 132 more accurately corresponds with and/or mimics the nonlinear relationship between the changes in pressure relative to changes in flow volume of fluid being measured.

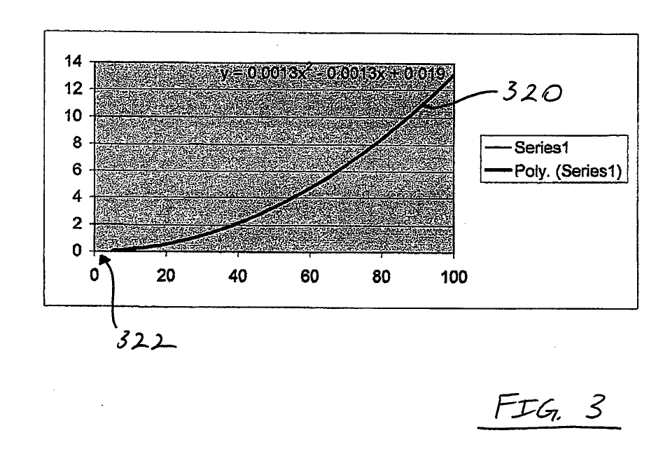

FIG. 3 shows an approximate half parabolic curve 320 graphically representing the half parabolic shape of the curved portion 132 of the manometer 120 according to some embodiments. The half parabolic curve represents a second order interaction polynomial, with the vertical axis being a height of a curved section 132 of the manometer in inches (e.g., with a total height of 13.2 inches) and the horizontal axis represents the percent pressure change based on full scale dimensions along the length 138 of the curved portion 132 (e.g., a length of 22 inches). Table 1 defines the plot points of the half parabolic curve 320. In some embodiments, the vertical displacement points are adjusted to correlate with the second order polynomial. For example, the vertical axis points defined in Table 1 can be estimated values that are adjusted according to the second order polynomial to provide the adjusted vertical points. In some implementations, the adjusted vertical points are determined based on an extrapolation of the initial vertical points (e.g., as generated through Microsoft's Excel® program). It is noted that the slope of the curve 320 increases as the half parabolic curve extends away from the vertex 322.

TABLE 1

| % of | Vertical Axis | Horizontal Axis | Adjusted Vertical |
|---|---|---|---|
| Scale | (Height) | (Length) | Points |
| 5 | 0.04 | 1.1 | 0.045 |
| 10 | 0.12 | 2.2 | 0.136 |
| 15 | 0.27 | 3.3 | 0.292 |
| 20 | 0.55 | 44 | 0.513 |
| 25 | 0.84 | 5.5 | 0.799 |
| 30 | 1.2 | 6.6 | 1.15 |
| 35 | 1.61 | 7.7 | 1.566 |
| 40 | 2.1 | 8.8 | 2.047 |
| 45 | 2.65 | 9.9 | 2.593 |
| 50 | 3.24 | 11 | 3.204 |
| 55 | 4.0 | 12.1 | 3.88 |
| 60 | 4.73 | 13.2 | 4.621 |
| 65 | 5.49 | 14.3 | 5.427 |
| 70 | 6.47 | 15.4 | 6.298 |
| 75 | 7.34 | 16.5 | 7.234 |
| 80 | 8.43 | 17.6 | 8.235 |
| 85 | 9.51 | 18.7 | 9.301 |
| 90 | 10.65 | 19.8 | 10.432 |
| 95 | 11.87 | 20.9 | 11.628 |
| 100 | 13.2 | 22 | 12.889 |

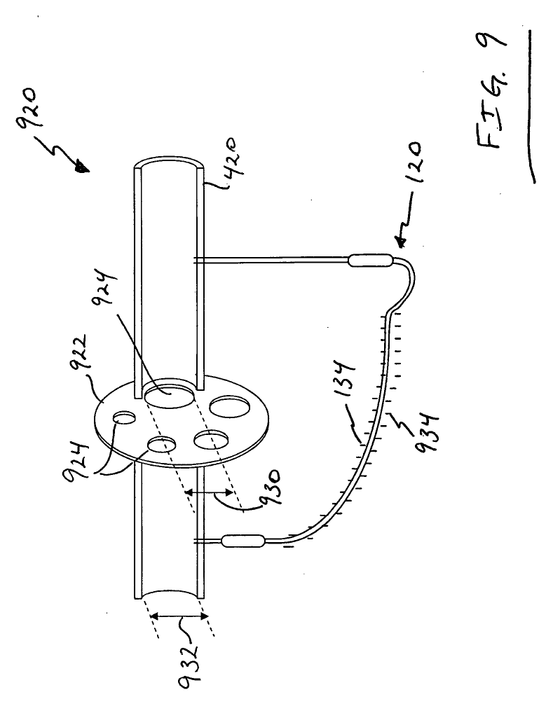

Due to the reduced slope of the lower portion 222, the amount of pressure change needed to push the displacement fluid 146 along the lower portion of the conduit is reduced compared to other types of manometers, such as incline manometers. Further, the half parabolic shape of the manometer correlates to the nonlinear relationship of pressure change to volume of flow, such as the nonlinear relationship between pressure change to volume of flow as the fluid is pushed through a known metering device comprising a square edge orifice arranged in some implementations perpendicular to the flow as described fully below, or at angles to the flow (e.g., at 45 degrees to the flow), and accommodates the physics of the fluid flow across the orifice. FIG. 4 depicts a cross-sectional view of a source conduit 420 with a flow restriction plate 422 positioned perpendicular to the length of the source conduit 420. The restriction plate includes, in some implementations, a square edge circular orifice 424 with known dimensions through which fluid is forced. Additionally and/or alternatively, in some implementations the restriction plate 422 is a large disc, strip or other structure that included multiple orifices 424 of different sizes and/or dimension to allow different orifices to be transitioned into alignment with the conduit 420 depending on the source of fluid flow and/or expected pressures being measured (see for example, FIG. 9). At low pressures, the flow passes relatively easily though the orifice 424. A nonlinear increase in pressure change is typically needed to increase the amount of fluid pushed through the orifice. This nonlinear pressure change continues to increase reaching a sonic condition at which point the orifice substantially chokes the flow requiring massive increases in pressure with little or no increase in flow.

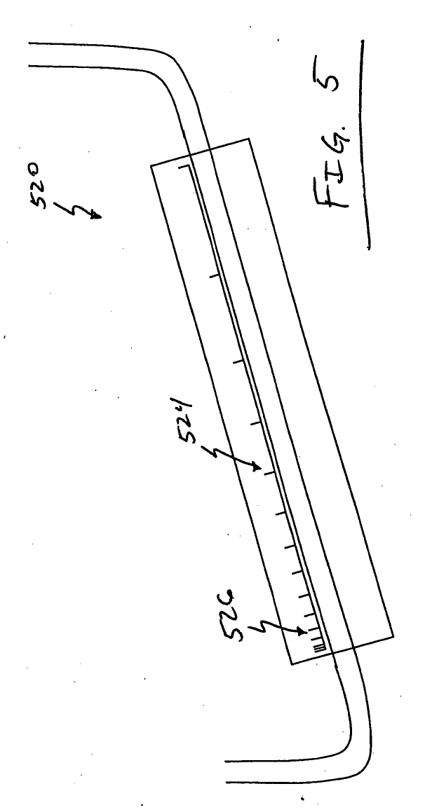

Previous manometers include vertical and inclined manometers. FIG. 5 depicts a simplified block diagram of a typical incline manometer 520. The slope of the incline manometer is constant throughout the length 522 of the manometer. Due to the constant slope, the scale 524 along the tube is generally logarithmic and thus is compressed in regions 526 reflecting the nonlinear pressure/flow conditions as the flow approaches sonic conditions when passed through a square edged orifice. Because of the logarithmic scale, the measurements at lower flows or pressures are difficult due to the loss of resolution of the scale at the lower portion 526 of the scale 524 resulting in inaccurate readings.

Alternatively, the generally half parabolicly curved manometers of the present embodiments provide distributed pressure gradients along the curve. Referring again to FIG. 2, the curved portion provides for a more accurate measurement at least with respect to lower flow rates and/or pressures. In some embodiments, the substantially half parabolic shape of the curved portion 132 is configured to correlate with and/or generally mimic a nonlinear relationship between pressure and fluid flow, such as fluid flow through a square edged orifice or other metering orifice that demonstrates nonlinear pressure relationship between fluid flow and the pressure change. As such in some implementations, a linear distance displacement 230 of the displacement fluid 146 for a predefined percentage change in pressure is approximately equal along the curved portion 132.

Further, due to the approximately equal linear displacement of the displacement fluid 146, the scale 134 is approximately equally linearly distributed along the curved portion 132 of the manometer 120. For example in some implementations of the manometer 120, a first linear distance displacement 240 is equal to a one percent change in pressure and/or pressure difference. As such, the scale is not logarithmic and instead can be configured to define one percent changes of pressure along the length of the curved portion, or substantially any resolution of linear gradients desired depending on intended implementations. Further, because the linear displacement of the fluid 146 relative to pressure change is substantially equal across the curved portion 132 of the manometer, the lower portion 222 has a gradient distribution that is generally equal to that at the upper portion 224 providing a more accurate and precise measure along the manometer including at lower pressures or small differences of pressure changes.

In some embodiments, the scale 134 is based on a percentage of fluid flow being measured. The gradients 136 of the scale can thus define percent changes (e.g., 1%) of pressure. The scale can extend from zero percent (0%) 242 to one hundred percent (100%) 244 based on a predefined expected maximum flow. The curve can be fit to provide the generally equal linear displacement 240 for each gradient (e.g., 1% gradient). The total rise or height 246 of the curved portion 132, at least in part, dictates the maximum percentage that is measured. For example, the manometer 120 can use water as the displacement fluid 146 for measurement displacement, and the curved portion 132 can have a height of about 12 inches. Depending on the diameter of the conduit 130, the scale defines a 100% pressure variation equal to about 0.5 psi. As another example, with reference to the half parabolic curve 320 of FIG. 3, a curved portion 132 of the conduit 130 having an thickness of 0.25 inch and an interior conduit diameter through which the fluid 146 flows of 0.125 inches, a height of 13.2 inches, and a length of 22 inches, with water and a wetting agent as the displacement fluid 146, the nonlinear measured pressure difference relative to a source flow being measured provides a pressure difference of approximately 0.47 psi at 100%. The dimensions of the manometer and/or conduit can vary depending on the desired implementation and the expected pressures to be measured.

In some additional and/or alternative embodiments, the scale 134 can slightly vary from linear along the curved portion to compensate for limited and/or interference with movement of the displacement fluid. For example, the slope of the lower portion 222 of the conduit 130 can be altered (e.g., slightly increased) to compensate for interference with displacement fluid movement (e.g., due to cohesion). This slight altering of the lower portion 222, however, is minimal and the spacing from the graduations 136 only slightly differs from than those for example in the middle section of the scale. Therefore, some embodiments comprise a scale 134 that is linear along the length and/or curve of the manometer at least for graduations defining about 50% fluid flow and greater, while at least some of the graduations below about the 50% fluid flow would be slightly greater than those above about the 50% scale point. In some further implementations, the scale graduations proximate the zero point 162 can be further altered to have more progressive markings.

In some further embodiments, the scale 134 is used to measure pressure in direct units such as pounds per square inch, or kilograms per square centimeter. In this case, the gradients 136 of the scale 134 can be distributed in non-linear distances along the curved portion 132 of the manometer 120. In use, as the displacement fluid 146 rises up into the steeper area of the curved portion 132 of manometer 120, typically more pressure is applied to raise the fluid in a similar linear distance inside the conduit or tube. In this embodiment, the graduations of the scale are not equally spaced along the curve, and in some implementations are be configured generally logarithmic along the curve to reflect the relationship of pressure to the rise in fluid column inside the conduit or tube 130. With the scale implemented in this implementation, very low pressures are registered accurately while a more tightly spaced pattern is employed higher up on the scale 136. Skilled artisans will appreciate the advantages such a configuration will provide in the readings of lower pressures commonly found in minor pressure drops as in low flow conditions across a square edged orifice or other such restriction along a conduit.

Referring to FIGS. 1 and 2, additionally and/or alternatively, the scale 134 can define changes in pressure or flow instead of percentages of changes. For example, the scale 134 can define a flow of fluid in cubic feet per minute (cfm). The conduit 130 and scale 134 can be configured to define a maximum of flow (e.g., 400 cfm) change from the zero point 162. Therefore, a 20% change in pressure is measured at 80 cfm.

It will be apparent to those skilled in the art that the dimensions of the curved manometer can be varied without departing from the novel aspects of the present embodiments. For example, the height 246 and length 138 can be increased or decreased to accommodate greater or lower pressure ranges, respectively, while still maintaining the substantially equal fluid linear distance displacement 240 of the scale gradients 136. Additionally and/or alternatively, the diameter of the conduit 130 can be altered to accommodate different expected maximum pressure levels, such as increased to increase the total volume of displacement fluid 146 displaced and thus allow for a greater pressures to be measured.

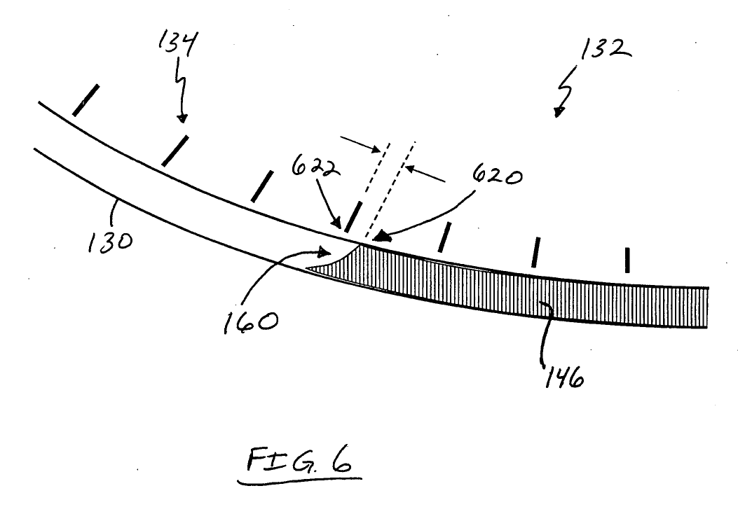

In some embodiments, the scale 134 is positioned along the curved portion 132 of the conduit 130 with the displacement fluid 146 being displaced due to a pressure difference applied to the manometer. Based on known pressures applied to the manometer, the scale can be calibrated to set the scale to match the known pressure or percentage. For example, this can be accomplished by cooperating the manometer with a secondary conduit with a known pressure difference. FIG. 6 depicts a further zoomed in view of a section of the curved portion 132 of the conduit 130 of FIG. 2 with known pressure difference applied to the terminations 154, 156. The known pressure difference causes the displacement fluid 146 to be displaced along the curved portion 132 to a measurement point 620. In some instances when calibrating, the measurement point 620 should correspond with a known scale measurement point 622 (for example, 30%) based on the known flow. Due to a slight mis-alignment of the scale 134 with the curved portion 132, the measurement point 620 based on the meniscus 160 of the displacement fluid 146 does not precisely align with the expected scale factor. Based on the measured difference, the scale may be adjusted to calibrate the scale to within a desired tolerance accuracy (e.g., within a tolerance of less than 1% in some embodiments). Some present embodiments allow the scale 134 to be slid or shifted at least a small distance along the length of the curved portion to allow alignment of the expected scale factor to the meniscus 160.

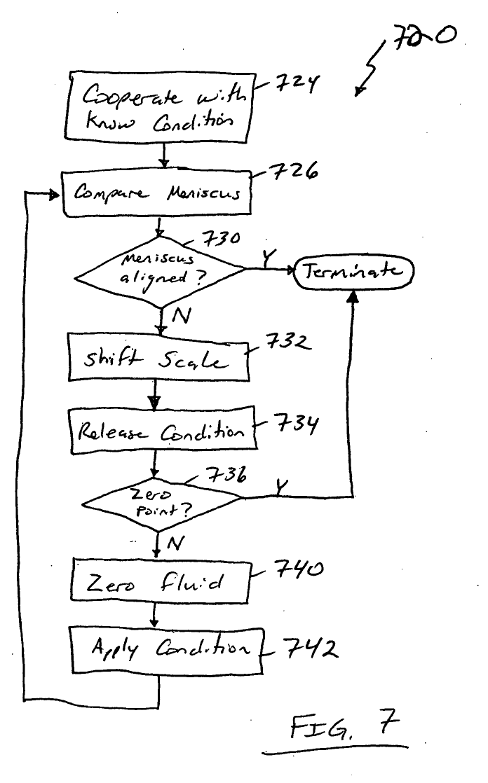

FIG. 7 depicts a simplified flow diagram of a process 720 for use in the calibration of the scale 134 of a manometer of the present embodiment to provide accurate measurements of unknown pressures and/or flows. Referring to FIGS. 6 and 7, in step 724, the manometer is cooperated or coupled with a known pressure, known pressure difference, a fluid flow with a known rate, or other such known conditions. The known condition causes the displacement fluid 146 in the reservoir to be forced along the conduit to a generally static point based on the known condition. In some implementations, a second manometer (e.g., a vertical manometer) is cooperated with a second or the same source conduit, and a pressure difference is applied to the second manometer. The known pressure difference is defined by the measure of the vertical manometer with a predefined amount of fluid flow. The half parabolic shaped manometer of present embodiments is similarly cooperated with a source conduit with similar, the same and/or a multiple of the predefined pressure difference applied when measuring with the second manometer (e.g., same amount of fluid flow applied).

In step 726, the meniscus 160 of the displacement fluid forced along the conduit is compared with an expected measurement point 622. In step 730, it is determined whether the meniscus 160 aligns with expected measurement point 622, typically within a tolerance or threshold. If the meniscus is aligned, the process is terminated. Alternatively, when the meniscus does not align, step 732 is entered where the scale 134 is shifted so that the expected measurement point 622 aligns with the meniscus 160. The shifting of the scale is achieved in some implementations by recalculating the curve and the points along the curve based on measured reference or known pressure differences (e.g., measured with the vertical manometer). In some implementations, steps 726-730 are applied to multiple different pressures prior to proceeding to step 734.

In step 734, the known pressure or condition is released. In step 736, it is determined whether the displacement fluid 146 returns to the zero point 162 (see FIG. 1), typically within a tolerance or threshold. When the meniscus of the displacement fluid returns to the zero point the process terminates. Alternatively, when the manometer is not zeroed, step 740 is entered where the manometer is zeroed by moving displacement fluid (e.g., by shifting the reservoir level up or down in a generally vertical plane). In step 742, the known condition or an alternative known condition is re-applied to the manometer. The process then returns to step 726 to determine the positioning of the meniscus 160 relative to the expected measurement point 622. The iterative process defined by the loop of steps 726 through 742 can be repeated any number of times until the scale is aligned with the known condition(s) to within a desired threshold. A similar calibration process can be employed in some implementations to initially define the scale 134 along a substantially half parabolic shaped curved portion. Multiple known conditions can be applied to a manometer and the locations of the meniscus marked to define the substantially linearly distributed scale 135.

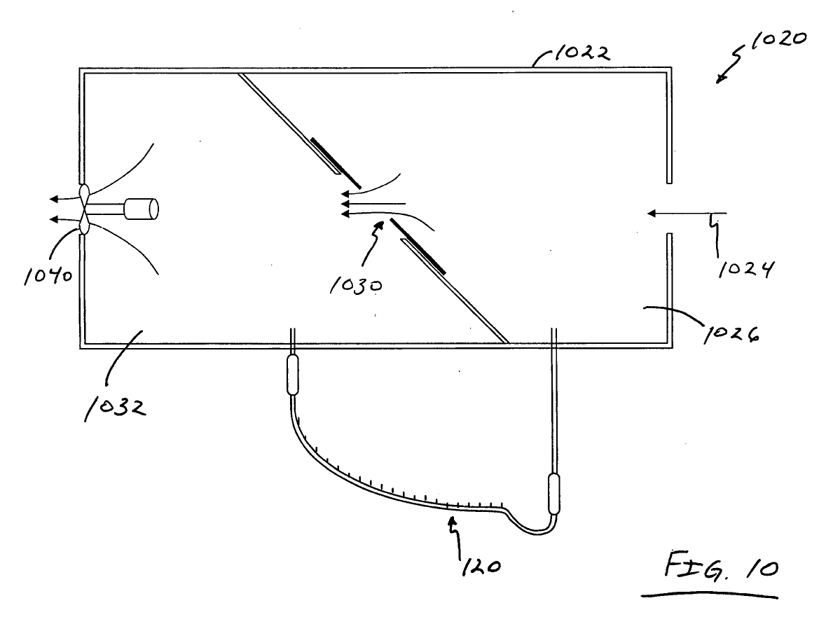

In some embodiments, the process 720 is applied to two different manometers, a reference manometer and a manometer to be calibrated, such as a curved manometer of the present embodiments. The reference manometer provides the known pressure measure and is positioned across a first square edged orifice of known conditions with known flow to pressure relationships and equations for the conditions as is known in the art (e.g., based on length of approach to orifice, surface treatment of source conduit, size and/or shape of orifice, positioning of orifice relative to conduit, and other such known conditions), and the manometer to be calibrated is positioned across a second square edged orifice. The first and second orifices can be the same size, but in some instances are multiples of each other, such as the first orifice can be 80% the diameter of the second orifice, and are positioned in series (e.g., the orifice 424 in conduit 420 in series with conduit 1030 of FIG. 10, described below).

Pressure differences are measured across the orifices at multiple fluid flows (e.g., measurements at about 10%, 20%, 30%, 40% and up to about 100% of flow from a predefined source). The measurements from the reference manometers are compared with the measurements from the curved manometer. The accuracy of the curved manometer is determined based on the reference measurements and the known equation, and the scale and/or curve can be adjusted according to the accuracy as described above. In some implementations, the scale is linear along regions as described above and adjustments are made to the regions of the scale to achieve the desired accuracy within a desired threshold. Typically, the scale is adjusted at least along a region of the scale when that region does not meet within a predefined relationship with respect to an accuracy threshold, such as achieving an accuracy of about less than 5%, and preferably in some implementations less than 2%.

As introduced above, the manometer 120 is typically secured with a mounting, board, plate or other support structure 150. The board 150 can be formed of plastic, melamine, wood, metal, and other such materials or combinations of materials. The conduit 130 and/or other components of the manometer are secured with the board through one or more various methods, such as clamps, adhesive, pegs, one or more grooves, or other such methods and combinations of methods. The scale 132 can also be secured with the board 150 through similar methods.

In some embodiments, the board includes a groove or channel within which the conduit 130 is mounted. The groove can be cut into the board, be a separate piece that is secured with the board, formed as the board is formed (e.g., through injection molding), and other such implementations. Additionally and/or alternatively, support pegs can be included to support and position the manometer with the board 150. In some embodiments, multiple scales can be included and/or interchanged for use with different source conduits. For example, the multiple scales compensate for a beta factor and have realigned percent of flow markings according to the different source conduits and/or orifices as further described below.

In some embodiments, the manometer 120 includes a cover and/or is enclosed in a housing to protect users in case the manometer ruptures during operation. The enclosure can have a housing positioned around the manometer 120, and a cover that is at least partially transparent extending over the manometer, such as Plexiglas, glass or other similar materials. The terminal ends 154 and 156 of the manometer can extend through the housing. Additionally and/or alternatively fittings can be secured with the housing and fixed with the terminal ends to allow the manometer to be connected with one or more pressure sources. The fittings can be threaded fittings or substantially any relevant fitting that allows the connection with a pressure source.

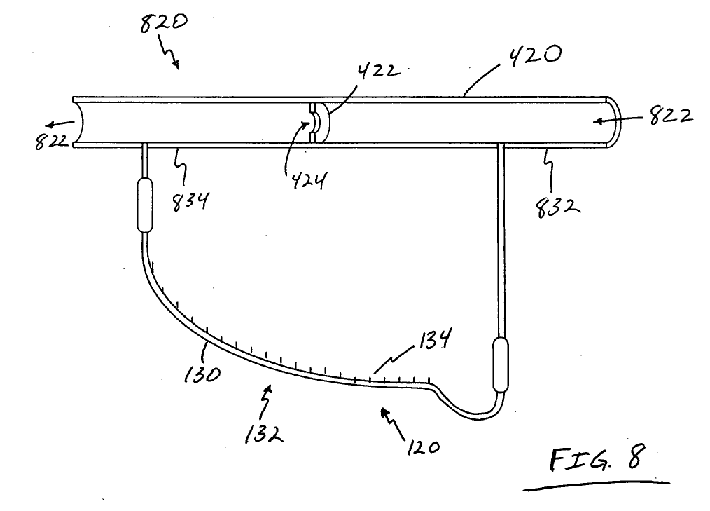

As introduced above, the manometer 120 of the present embodiments can be utilized to measure flow or flow differentials of a conduit through which displacement fluid is driven. FIG. 8 depicts a simplified cross-sectional view of a measurement system 820 for use in measuring fluid flow. The measurement system includes a source conduit or tube 420 cooperated with a manometer 120. A fluid is pushed or pulled through the source conduit 420 in the direction indicated by arrow 822. As the fluid traverses the length of the source conduit, the fluid is forced through a square edged circular orifice 424 formed in a disc or plate 422 positioned generally perpendicular to the length of the source conduit. Due to the inclusion of the plate 422 with the square edged orifice, a pressure difference is established on either side of the orifice 424. The second termination 156 of the manometer 120 is fixed with the source conduit 420 on a first or upstream side 832 of the orifice and the first termination 154 is fixed with the source conduit 420 on a second or down stream side 834 of the orifice.

The displacement fluid 146 (see FIGS. 1 and 6) within the manometer conduit 130 is forced along the curved portion 132 as a function of the pressure difference seen between the upstream side of the source conduit 832 and the down stream side of the source conduit 834. The scale 134 along the curved portion 132 of the manometer can be configured to define a percentage of pressure difference that is detected between the upstream and downstream sides. Utilizing the percentage difference a flow capacity through the orifice can be determined. For example, when the manometer reads a percentage pressure difference of 20% and a known maximum flow capacity is 400 cfm, the flow capacity at measurement equals about 80 cfm (400×20%). Alternatively and/or additionally, the scale can be configured to define a flow capacity through the orifice.

The manometer 120 is easily cooperated with substantially any size source conduit 420 with substantially any sized square edge circular orifice to allow the manometer to measure pressure differences for different types of devices supplying different levels of flow. In some embodiments, the measurement system 820 can include a plurality of different source conduits, each with a different sized orifice. This allows the manometer to be quickly and easily connected to different flow levels to accurately measure flows for different devices. For example, a small engine may force or pull a small amount of fluid flow (e.g., 40 cfm) while a larger engine may force or pull a larger amount of fluid flow (e.g., 400 cfm). As such, the multiple source conduits with differing sized orifices allow the same manometer to be used to measure a pressure difference for different types of flow by cooperating the manometer with a source conduit with the appropriately sized orifice 424 based on the estimated and/or anticipated flow.

In some implementations, a plurality of orifices are used to measure pressure differences and/or are available depending on the amount of flow to be measured. FIG. 9 depicts a partial cross-sectional view of a pressure measurement system 920 according to some embodiments with a flow restriction orifice disk 922 that includes a plurality of orifices 924, each with a different diameter 930. The disk 922 can be rotated to allow positioning of the orifices in alignment with the source conduit 420. Other structures with multiple orifices can be employed instead of a disk that allows the varying sized orifices to be positioned in alignment with the source conduit. As is known in the art, the orifices cause a variation in the fluid flow, including a beta factor effect that is defined at least generally as a ratio between the diameter of the orifice 930 to the diameter of the source conduit 932. As such, the smaller the beta ratio, the less air flow and the larger the ratio the greater the air flow. The variously sized orifices 924 cause variations in fluid flow patterns that restrict flow. This restricted flow is defined at least in part by the beta ratio.

In some implementations of the half parabolic manometer 120 used with an orifice disk 922 or used with a variety of sized orifices, the scale 134 accuracy can vary depending on the beta ratio. As a result, some embodiments employ a plurality of scales 134, 934 that are used depending on the beta ratio when a pressure difference is measured. For example, a first scale 134 can be used when measuring fluid flow with beta ratios at or below about 0.50 (50%), and the second scale 934 can be used when the beta ratios are at about 0.50 or greater. The scales vary by separations of gradients and/or the positioning of the gradients may be slightly shifted. Additionally and/or alternatively, two or more removable scales can be employed such that these scales can be interchanged depending on the beta ratio. The use of multiple scales allows the half parabolic manometer 120 to be used with a wide variety of orifices while maintaining measurement accuracy to within a desired threshold tolerance (e.g., less than 5%, preferably less than 2%, and with some implementations an accuracy of 1% or less). The calibration process 720 of FIG. 7 and/or other similar calibration processes can be employed with each scale 134, 934 (whether fixed or removable) to enhance accuracy.

FIG. 10 depicts a simplified cross-sectional view of a flow bench system 1020 for use in measuring fluid flow according to some embodiments employing a half parabolic manometer 120. The measurement system 1020 includes a source enclosure 1022 that can be configured as a conduit, tube, box or other structure. Fluid 1024 is forced or drawn into a first plenum 1026 of the enclosure 1022 and through an orifice 1030, such as a square edged circular orifice, and into a second plenum 1032. As the fluid 1024 passes through the orifice a pressure drop results establishing a pressure difference. In some implementations, a fan 1040 or other device pulls the fluid and expels the fluid from the second plenum 1032. The pressure difference is a non-linear pressure difference as the fluid flow increases, and this nonlinear change is accurately measured and tracked by the manometer 120. In the example shown in FIG. 10, the orifice 1030 is shown at an angle to the fluid flow, such as at a 45 degree angle to the fluid flow. The orifice 1030, however, can be configured in other orientations to measure pressure differences such as perpendicular to the fluid flow, or other angles to the fluid flow.

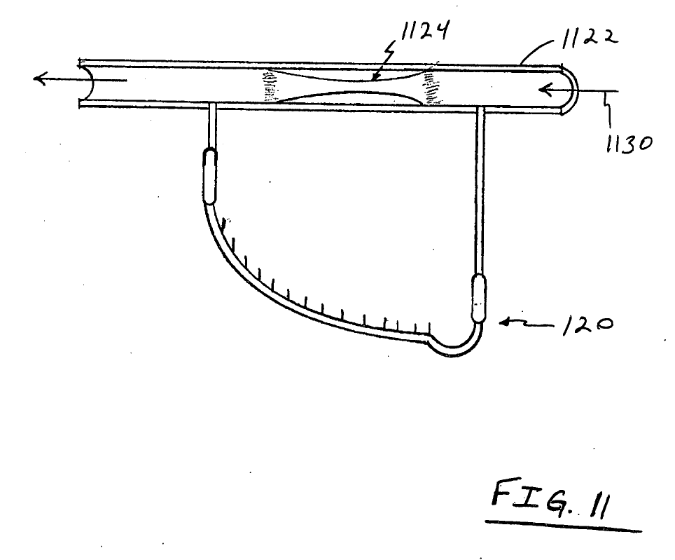

FIG. 11 depicts a simplified cross-sectional view of an alternate measurement flow bench system 1120 for use in measuring fluid flow. A half parabolic manometer 120 according to present embodiments is coupled with a source conduit 1122. A tapering orifice 1124 is incorporated into the source conduit. In some implementations the tapered orifice 1124 is formed as a Venturi style orifice. The manometer 120 is cooperated with the source conduit such that the terminal ends are on either side of the venture orifice 1124. As fluid 1130 is pushed or pulled through the source conduit the pressure difference is measured by the manometer 120.

The present embodiments can be used in measured substantially any flow and/or pressure difference. Cooperating the half parabolic manometer 120 with a flow bench (e.g., flow bench 1022) allows for accurate measuring of flow. For example, the parabolic manometer and flow bench can be used to accurately test a cylinder head of an internal combustion engine for flow performance. When testing a cylinder head, in some implementations, an adaptor can further be used to provide a convenient method for interfacing the cylinder head with the flow bench and to force the cylinder head to operate in a similar manner as it would if it were installed in an engine. Typically, the cylinder head adaptor used closely mimics the size and shape of an actual cylinder bore of an engine to achieve more realistic measurements. The cylinder head adaptor can include a static pressure tap, for example, a tap installed approximately midway on the cylinder portion immediately below the cylinder head for measuring a test or static pressure. Generally, a static or test pressure is a combination of the local speed of the air traveling over a pressure tap and the density or pressure of the air in relation to standard atmosphere. The single tap configuration, however, measures static pressure in one location. As local flow conditions inside the adaptor typically vary, static or test pressure can also vary, and can be subject to pulsation, turbulence, and other adverse conditions.

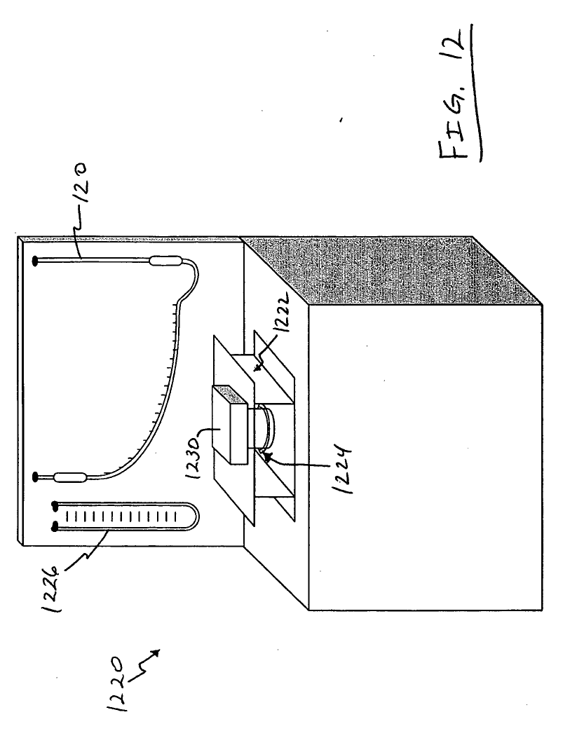

FIG. 12 depicts a simplified block diagram of a flow bench 1220 according to some embodiments, with an adaptor 1222, a piezometric ring 1224, and one or more manometers, such as a half parabolic manometer 120 and a test or reference pressure manometer 1226. The adaptor 1222 allows a source of fluid flow 1230 (e.g., a cylinder head or other source) to be mounted with the flow bench 1220 for measuring fluid flow to or from the source 1230.

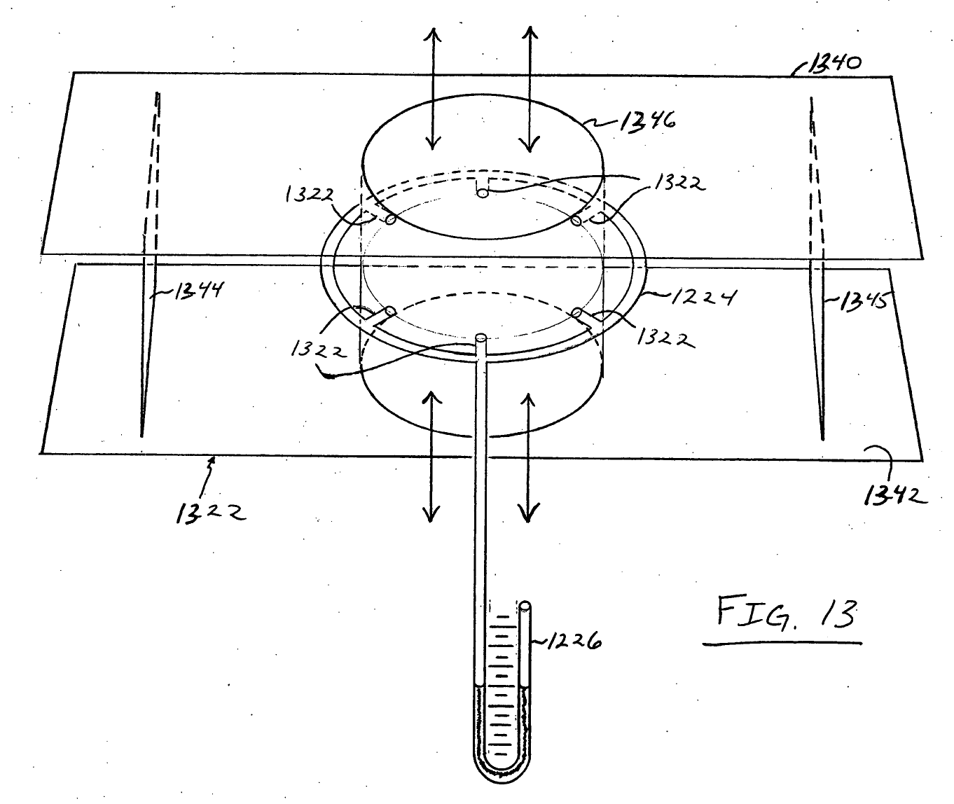

FIG. 13 depicts a simplified, partially transparent isometric view of the adaptor 1222 and piezometric ring 1224 cooperated with the reference manometer 1226. Referring to FIGS. 12 and 13, the adaptor 1222 includes a mounting plate 1340, a base plate 1342, supports 1344-1345, and a source passage or conduit 1346. The base plate 1342 is used in part to secure the adaptor with the flow bench 1220. A source of fluid flow can be secured with the mounting plate 1340 and the source passage 1346 to force fluid and/or draw fluid through the passage. In some embodiments, the piezometric ring 1224 is constructed of one or more tubes encircling the source passage 1346 and further includes a plurality of ports or taps 1322 that cooperate with the passage.

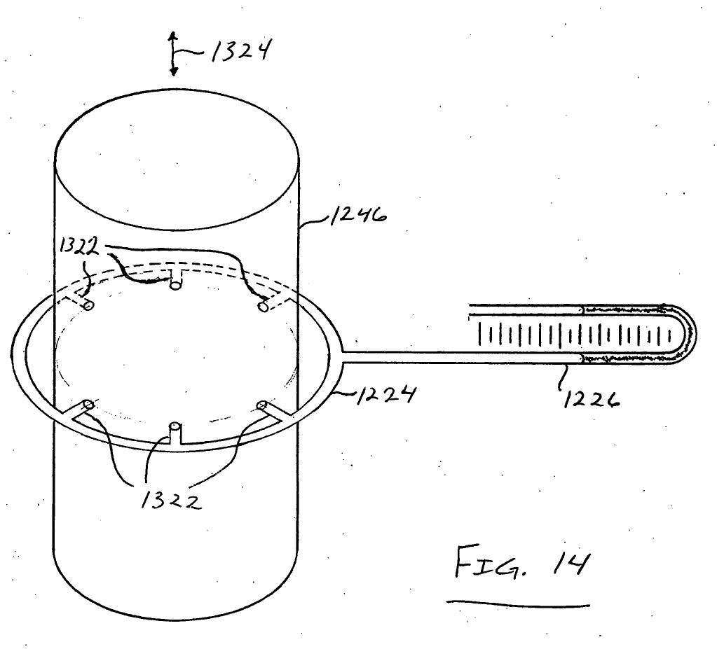

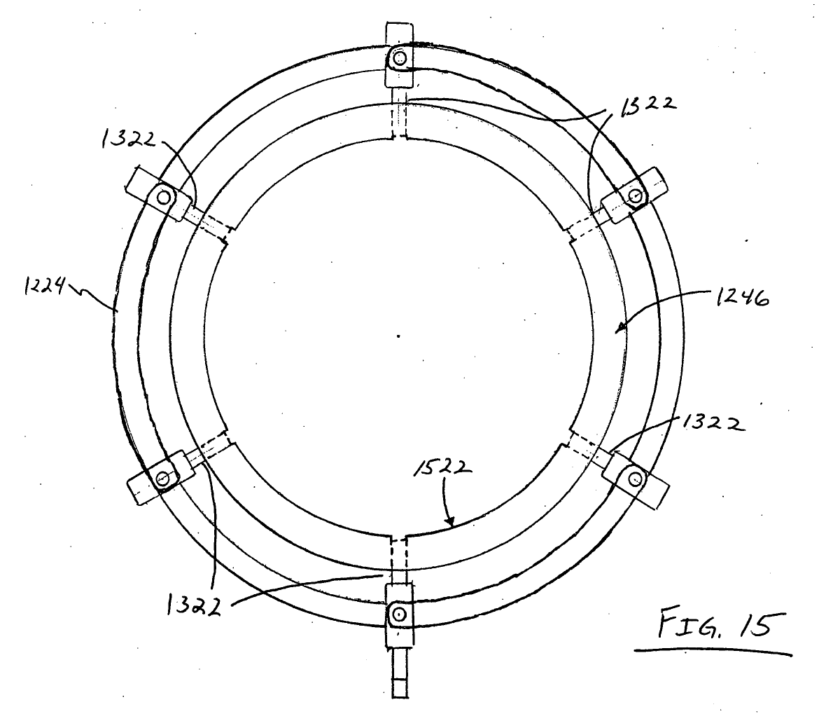

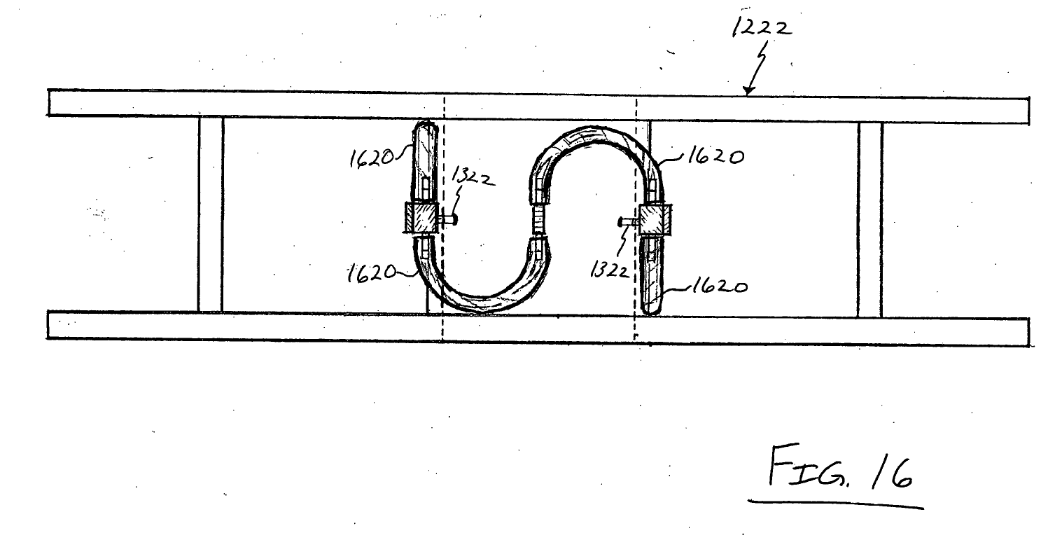

FIG. 14 depicts a partial transparent isometric view of the piezometric ring 1224 cooperated with the source passage 1346 and reference manometer 1226. FIG. 15 depicts an overhead view of the piezometric ring 1224 cooperated with the source passage 1346. The ports 1322 of the piezometric ring 1224 extend into the wall of the source passage, and in some implementations terminate flush with the interior wall 1522 of the source passage 1346. The piezometric ring 1224 further cooperates with the reference manometer 1226, in the embodiment shown, implemented through a U-shaped manometer. FIG. 16 depicts a cross-sectional view of the adaptor 1222 and piezometric ring 1224 according to some implementations. The piezometric ring 1224 is positioned to encircle the source passage. Further, the ring is configured with a serpentine or “S” configuration about the source passage. A plurality of tubes 1620 are connected to form the ring and cooperated with the plurality of ports 1322.

Referring to FIGS. 12-16, the flow bench 1220 employs the piezometric ring 1224, at least in part, to establish an average static pressure across an area or surface from the source of fluid flow 1230 (e.g., a cylinder head or other source). The piezometric ring 1224 cooperates with the cylinder head and establishes a more consistent measure of pressure. The plurality of ports 1322 are arranged around the source conduit 1346 in series, arranged generally radially around a test section. In some implementations, a number of rings can further be disposed axially along the source conduit allowing the monitoring of pressures at different locations. Stable static pressure readings are achieved using the piezometric ring 1224, where the readings have little or no pulsation, variation, or other effects, and thus, improves repeatability.

The reference manometer 1226 is used to measure the static pressure within the source conduit 1346 allowing for more precise repeatability, and further helps to ensure accurate measurements of fluid flow within the flow bench 1220 utilizing the half parabolic manometer 120. Additionally, the reference pressure measured using the reference manometer 1226 allows a user to make comparisons between different tests of the same source 1230 and/or different sources. The piezometric ring 1224 further enhances the accuracy of the reference pressure by providing an averaging static condition on the reference manometer 1226 compensating for variations within regions of the source conduit 1346. Still further, the piezometric ring is positioned about the source conduit 1346 in close proximity to the source 1230 to obtain accurate measures close to the source.

As indicated above, the curved manometers of the present embodiments can be used to measure fluid flow and/or pressure for numerous applications, and substantially any non-linear pressures, pressure differences and/or volume flows. For example, the manometer 120 can be used in substantially any application where an incline manometer could be employed. Similarly, the manometer 120 of the present embodiments could be used with reverse log scales. As a further example, the manometer 120 can be used in measuring the induction of air and/or fuel to a cylinder head of a combustion engine and/or the expulsion of exhaust after combustion in attempts to maximize the flows. The manometer can be coupled with a source conduit that delivers air (and/or fuel) through a square edged orifice to an engine to quantify the amount of air that is drawn in through the component or system of the engine. Based on the measured pressure difference on either side of the orifice the fluid flow of the air is accurately determined, even at low pressures due to the substantially half parabolic shaped manometer of the present embodiments. Once the pressure difference is known through the orifice, it is a matter of applying the measured pressure difference to known equations, such as those defined and published by the American Society of Mechanical Engineers in “Fluid Meters, Their Theory and Applications” sixth edition, 1971, incorporated herein by reference.

While the invention herein disclosed has been described by means of specific embodiments and applications thereof, numerous modifications and variations could be made thereto by those skilled in the art without departing from the scope of the invention set forth in the claims.

What is claimed is:

1. An apparatus for use in measuring pressure, comprising:
a manometer comprising a conduit having a curved portion that is substantially half parabolic in shape;
a pattern of markings spaced along the curved portion of the conduit; and
a displacement fluid maintained within the conduit that is forced along at least a portion of the curved portion of the conduit when the manometer is subject to a pressure difference.

2. The apparatus of claim 1, wherein the half parabolic shape corresponds to a nonlinear relationship of a pressure change to a volume of fluid flow.

3. The apparatus of claim 1, wherein the half parabolic shape corresponds to the nonlinear relationship of the pressure change to a volume of fluid flow through a square edged circular orifice.

4. The apparatus of claim 1 wherein the pattern of markings are substantially equally spaced along at least a portion of the curved portion of the conduit.

5. The apparatus of claim 4, wherein the pattern of markings are substantially linearly spaced along the curved portion of the conduit.

6. The apparatus of claim 1, wherein the manometer further comprises first and second ends with first and second terminations, respectively, wherein the first termination is configured to couple with a pressure source.

7. The apparatus of claim 6, wherein the pressure source is defined by a fluid flow forced through a square edged orifice.

8. The apparatus of claim 1, wherein the conduit comprises polyurethane with an interior surface, wherein the interior surface of at least the curved portion of the conduit is treated to have a reduced surface tension.

9. The apparatus of claim 1, further comprising an additional pattern of markings extended along a length of the curved portion of the conduit.

10. An apparatus for use in measuring fluid flow, comprising:
a manometer comprising a conduit having a curved portion;
a pattern of markings substantially linearly spaced along at least a portion of the curved portion of the conduit; and
a displacement fluid maintained within the conduit that is forced along at least a portion of the curved portion of the conduit when the manometer is subject to a pressure difference.

11. The apparatus of claim 10, wherein the curved portion has a curved shape defined to correspond to a nonlinear relationship between a change in the pressure difference relative to a change in a flow volume of a fluid being measured.

12. The apparatus of claim 11, wherein the nonlinear relationship is represented substantially by a half parabola such that the curved shape of the curved portion substantially mimics the half parabola representing the nonlinear relationship between the change in the pressure difference relative to the change in a flow volume of the fluid being measured.

13. The apparatus of claim 12, wherein the nonlinear relationship between the change in the pressure difference relative to the change in the flow volume of the fluid comprises a difference between a first pressure on a first side of an orifice and a second pressure on a second side of an orifice as the fluid being measured is forced through the orifice.

14. The apparatus of claim 10, wherein the pattern of markings comprise gradients that are linearly distributed along the curved portion and represent a percentage difference in measured pressures.

15. The apparatus of claim 10, further comprising:
a piezometric ring positioned about a fluid flow source from which the pressure difference is generated.

16. A method for use in calibrating a scale of a manometer, the method comprising:
positioning a pattern of markings on the curved portion of the conduit;
directing a flow of fluid at a plurality of different flow rates to pass through a first orifice;
measuring a pressure difference across the first orifice for each of the plurality of different flow rates;
comparing the measurements across the first orifice with reference pressure differences;
determining an accuracy of the pattern of markings relative to results of the comparison of the measurements; and
adjusting at least a range of the markings on the curved portion of the conduit when a difference the accuracy of the pattern of markings in at least the range of markings has at least a predetermined relationship with respect to an accuracy threshold.

17. The method of claim 16, further comprising:
directing a flow of fluid at a plurality of different flow rates to pass through a second reference orifice aligned in series with the first orifice; and
measuring a pressure difference across the second orifice for each of the plurality of different flow rates;
wherein the comparing the measurements comprises comparing the measurements across the second orifice with the measurements across the first orifice.
